(19) United States
(12) Patent Application Publication
(10) Pub. No.: US 2009/0015158 A1
(43) Pub. Date: Jan. 15, 2009

(54) TCLP Compliant Integrated Compact Fluorescent Lamp

(75) Inventors: David C. Nesting, Salina, KS (US); Daniel E. Trevino, Monterrey (MX); Will Punt, Breda (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,990

(22) PCT Filed: Jun. 26, 2004
(86) PCT No.: PCT/IB2004/051019

§ 371 Date: Feb. 28, 2008

Related U.S. Application Data
(60) Provisional application No. 60/483,764, filed on Jun. 30, 2003.

(51) Int. Cl. H01J 61/00

(52) U.S. Cl. 313/567

(57) ABSTRACT

An integrated CFL lamp that is TCLP-compliant as to both mercury and lead is provided through the combination of (1) means to reduce the amount of leachable mercury in the spent lamp, preferably comprising a low mercury burner or other burners containing additives to reduce the amount of leachable mercury in the spent lamp; and (2) means to reduce the amount of leachable lead in the spent lamp, preferably comprising a circuit board that comprises a lead-free solder or such circuit board and at least one of a base portion and/or a lamp screw base portion that comprises a lead-free solder.

The invention relates to low-pressure mercury vapor integrated compact fluorescent lamps.

Low pressure mercury vapor lamps, more commonly known as fluorescent lamps, have a lamp envelope with a filling of mercury and a rare gas and in which a gas discharge is maintained during lamp operation. The radiation emitted by the gas discharge is mostly in the ultraviolet region of the spectrum, with only a small portion in the visible spectrum. The inner surface of the lamp envelope has a luminescent coating, often of a blend of phosphors, which emits visible light when impinged by the ultraviolet radiation.

While the use of fluorescent lamps was being promoted during the late 1980's and early 1990's, there was also growing concern about the disposal of an ever-increasing number of these lamps, due to their mercury content. In 1990 the Environmental Protection Agency (EPA) established the Toxicity Characteristic Leaching Procedure (TCLP) test which simulates the leaching effects of mildly acidic rainwater in landfills on solid waste. The test procedure is set forth at pages 26,987-26,998 of volume 55, number 126 of the Jun. 29, 1990 issue of the Federal Register (herein incorporated by reference). The lamp being tested is pulverized into granules having a surface area per gram of materials equal to or greater than 3.1 cm.sup.2 or having a particle size smaller than 1 cm in its narrowest dimension. The granules are then subject to a sodium acetate buffer solution having a PH of approximately 4.9 and a weight twenty times that of the granules. The buffer solution is then extracted and the concentration of mercury is measured. In order for fluorescent lamps to be considered non-hazardous and lawfully disposable in landfills (the cheapest option), the lamps must pass the TCLP test for mercury by meeting a regulatory threshold of 0.2 mg per liter (0.2 ppm) in the leachate.

U.S. Pat. No. 5,898,265 to Woodward et al and assigned to Philips Electronics North America, discloses and claims a fluorescent lamp that has a standard life of 20,000 hours (without reduced photometric performance) and which qualifies to be disposed of as non-hazardous waste without providing additional agents that act upon crushing of the lamp to convert mercury from one form to another, i.e., a TCLP-qualifying fluorescent lamp.

The TCLP compliance of fluorescent lamps has typically been limited to the discussion of mercury content and the leachability of mercury in the environment. Indeed, environmentally benign compact fluorescent lamps (hereafter referred to as “CFL” lamps) of the non-integrated type are presently on the market. However, it is a different story with integrated CFL lamps which have a printed circuit board inside the base of the lamp, which in turn contains the ballast and starting circuit. Such lamps contain lead in addition to mercury. For example, lead is commonly used in the solder employed to manufacture the printed circuit board used in the lamp. Lead may also be used in solder for joints in the lamp base and eyelet or other components of CFL lamps. Such integrated CFL lamps as presently configured are TCLP-compliant as to mercury but non-TCLP compliant as to lead. To be considered TCLP-compliant for lead, lamps must pass the TCLP test for lead by meeting a regulatory threshold of 5.0 mg per liter (5.0 ppm) in the leachate. To date, to applicant's knowledge, there are no integrated CFL lamps that are TCLP-compliant as to both mercury and lead.

As is well known, lead is a toxic, heavy metal accompanied by serious environmental concerns as well. Its use is disfavored and must be accounted for when in the disposal of products. Accordingly, there is a need in the art for integrated CFL lamps that are TCLP-compliant as to mercury and as to lead.

An object of the invention is to provide an integrated CFL lamp that passes the TCLP test as to both mercury and lead.

This and other objects is accomplished according to the present invention through the discovery that an integrated CFL lamp that is TCLP-compliant as to both mercury and lead can be realized through the combination of (1) means to reduce the amount of leachable mercury in the spent lamp, preferably comprising a low mercury burner or other burners containing additives to reduce the amount of leachable mercury in the spent lamp; and (2) means to reduce the amount of leachable lead in the spent lamp, preferably comprising a circuit board that comprises a lead-free solder or such circuit board and at least one of a base portion and/or a lamp screw base portion that comprises a lead-free solder.

According to one embodiment of the invention, a lighting unit is provided that comprises:

at least one low-pressure mercury discharge lamp having at least one light-transmitting discharge vessel which is provided with a luminescent layer on an inner surface and which encloses a discharge space provided with a gas fill energizeable to a discharge state and mercury in amounts effective to render the lamp TCLP compliant as to mercury;

a housing base on which said lamp is mounted, said base preferably being formed in a way suitable for mechanical and electrical connection to a lamp socket, and having a base portion connected to a cap portion;

a ballast circuit arrangement disposed within the housing located at least partially on a circuit board and effective to energize said gas fill to such discharge state; and

means to reduce the amount of leachable lead in the spent lamp to an amount sufficient to render the lamp TCLP-compliant as to lead.

In one embodiment of the invention, the means by which the amount of leachable lead in the lamp is reduced is the use of a lead-free solder at least in the construction of the printed circuit board.

In another embodiment of the invention, the means by which the amount of leachable lead in the lamp is reduced is the use of a lead-free solder in the construction of (a) the printed circuit board or (b) the printed circuit board and a base portion of the lamp, preferably a screw base portion of the lamp.

Suitable means for making the lamp TCLP-compliant as to mercury include employing a mercury protective coating on the inner surface of the lamp envelope and selecting a level of mercury, i.e. an initial mercury dose selected to be between an upper limit of about 0.2 mg/cm³ of the volume enclosed by the discharge vessel and a lower limit of about 0.02 mg/cm³.

In another embodiment, there is provided a low-pressure mercury discharge lamp, i.e. an integrated compact fluorescent lamp that includes a lighting circuit or supply unit, at least one arc tube, a base and an outer bulb, the arc tube having a discharge space with a filling of one or more rare gases in addition to mercury. In this discharge space a first and a second electrode are positioned, which electrodes each comprise a metal wire, preferably coated with one or more metal oxides which emit electrons, and which electrodes are each electrically connected to a respective current supply conductor which extends to outside the discharge vessel and is electrically connected there to the supply unit, which unit ignites the low-pressure mercury discharge lamp in the cold-state upon switching-on. The supply unit and the lamp are integrated into one unit. In one embodiment, the supply unit is provided with a high-frequency circuit arrangement with a first and second output terminal and may be provided with inductive and capacitive means. The first output terminal is connected to the current supply conductor of the first electrode via the inductive means, and the second output terminal is connected to the current supply conductor of the second electrode, while the further current supply conductors of the electrodes are interconnected via the capacitance means. The capacitive means together with the inductive means form a resonant circuit which causes an ignition voltage to arise after the lighting unit has been switched on.

To be useful herein, the lead-free solders must have a melting point low enough that it is compatible with the electronic components, preferable around 200 C, yet high enough to be stable under lamp operating conditions. In one embodiment, the following examples have been found to be useful: alloys of tin with copper, tin with silver, or ternary blends of all three elements as well as low levels of antimony may be used. Especially preferred is an alloy of about 97% tin and about 3% copper.

As disclosed above, the lamp is preferably provided with a dose of mercury. After the lamp is sealed, the mercury is released from the capsule into the discharge space enclosed by the envelope by inductively heating the glass capsule in a high frequency electromagnetic field, which causes the wire to cut the capsule. Such a capsule and technique are known from U.S. Pat. No. 3,794,402 (herein incorporated by reference).). Alternatively, the mercury may be incorporated as an amalgam to control light output as a function of temperature.

These and other features and advantages of the invention will be further described with reference to the following drawings in which

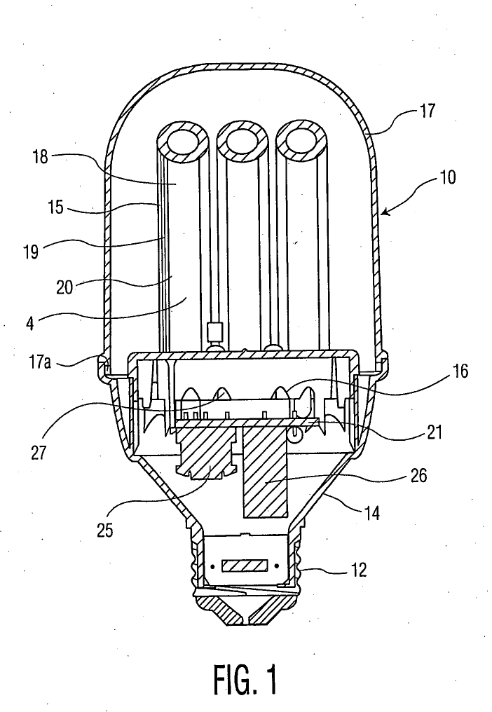

FIG. 1 is a side view of an integrated compact fluorescent lamp according to a first embodiment of the present invention, wherein the outer bulb or globe is illustrated as if the inside contents were visible.

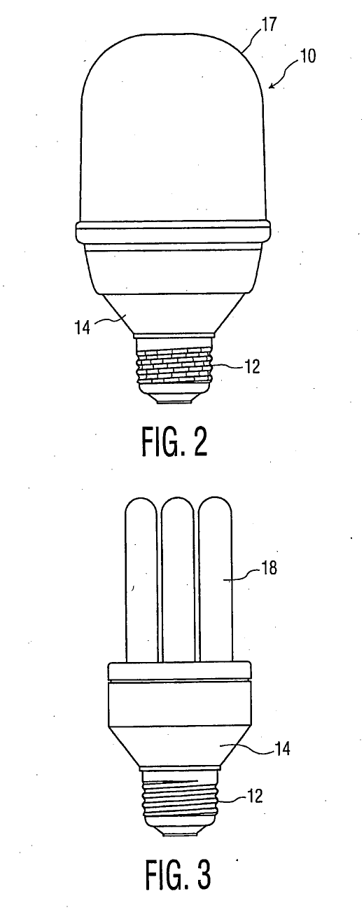

FIG. 2 is a side view of the same in which the outer bulb or globe is wherein the outer bulb or globe is illustrated as if the inside contents were not visible.

FIG. 3 is a side view of view of the integrated compact fluorescent lamp according to a second embodiment of the present invention.

According to the embodiments of the invention shown in FIGS. 1 to 3, a lighting unit in the form of an integrated compact fluorescent lamp 10 comprises a cover 14 having a base 12, a lighting circuit 16 contained in the cover 14, a light-transmitting outer bulb or globe 17, and at least one low-pressure mercury discharge vessel or arc tube 18. The lighting unit can serve as a replacement for an incandescent lamp. The discharge vessel 18 may be provided with a luminescent layer 15 on an inner surface as is well known in the art. The discharge vessel 18 encloses a discharge space 4, which is provided with a filling of mercury and argon in a gastight manner. The inner surface of the discharge vessel 18 may also be provided with a mercury-protective layer 19 and a phosphor coating 20 disposed over the layer 19. The layer 19 is provided to reduce the rate of mercury depletion. The layer 19 may be an oxide formed from the group consisting of magnesium, aluminum, titanium, zirconium and the rare earths. As used herein, the term “rare earths” means the elements scandium, yttrium, lanthanum and the lanthanides. When aluminum oxide is used for the mercury-protective coating, it has been found to substantially improve the lumen output of the lamp when applied in a coating weight of between about 0.15 mg/cm.sup.2 and about 0.3 mg/cm.sup.2. With a primary crystallite size of less than about 0.05.mu.m, the aluminum oxide is transmissive to visible light and reflective of ultraviolet radiation. However, adequate mercury protection for TCLP purposes is provided down to a coating weight of 0.08 mg/cm.sup.2. The aluminum oxide is applied in the manner described in U.S. Ser. No. 08/366,134 filed Dec. 29, 1994 U.S. Pat. No. 5,552,665 of Charles Trushell entitled “Electric Lamp Having An Undercoat For Increasing The Light Output of a Luminescent Layer” (herein incorporated by reference). Thus, in this embodiment, the initial mercury dose selected was between an upper limit of about 0.20 mg/cm³ of the volume enclosed by the discharge vessel and a lower limit of about 0.02 mg/cm³. Additionally, the use of a capsule-type dosing system has been found to be beneficial because the accurately measured dose is retained in the sealed capsule during lamp manufacture. The dose can be provided in the capsule in a relatively clean environment away from the main production line. After the lamp is sealed in a gas-tight manner with the sealed capsule inside the lamp envelope, the capsule is opened in a non-obtrusive fashion with a high frequency magnetic field. With this system, it has been found that the tolerances can be kept to within about 0.5 mg, which is sufficient at the low end to meet standard life while at the upper end to meet the TCLP requirements.). In the case of amalgam dosing, there is an alloy of mercury selected for the particular lamp geometry and operating conditions. These amalgams typically contain between 1.0 and 5.5 mg.

If other dosing systems are used, the mercury dose should be selected to account for the particular tolerances, so that the lamps can maintain the desired average lamp life, typically 10-12,000 hours, with the lowest expected mercury dose while passing the TCLP test at the high end of the mercury dose range expected with the particular dose tolerances.

The discharge vessel or arc tubes 18 are connected to one another to form a discharge path. The cover 14 and the base 12 are fastened together in any manner known in the art, preferably employing a lead-free solder or other lead-free bonding agent or by such other means as crimping. The outer bulb or globe 17 may be transparent or photo-diffusing and may be joined to the cover by an edge 17a fitted into an opening at the top of the cover 14.

The lighting circuit 16 contained in the cover 14 has a circuit board, preferably a printed circuit board 21. If desired, a plurality of circuit elements 25, 26, 27 may form an operating circuit of any suitable design for the lamp and may be are located at the bottom of the circuit as schematically shown in FIG. 1, and electrically connected to the printed circuit board tracks, not shown alternatively, the connections of the arc tube and circuit board may be of any means known in the art as long as lead-free solder is used and the introduction of additional amounts of lead is avoided.

According to a particular embodiment, the lamp shown in FIGS. 1 and 2 is an SLS lamp having a rated power consumption of 23 W. The lamp envelope has a length of about 8.2 cm., an internal volume of the discharge space of about 55 cm³. The phosphor layer 17 is a blend of red, green and blue phosphors having a coating weight of about 0.6 grams. The particular phosphor in the disclosed implementation is a blend of barium aluminate doped with manganese, cerium aluminate doped with terbium and yttrium oxide doped with lanthanum. In practice, any of a variety of phosphors can be used.

The electrodes carried a conventional emitter material of barium, calcium and strontium oxides.

### TCLP Compliance

Representative integrated CFL lamps of the invention were analyzed according to the TCLP procedures for mercury and lead described in SW-846, Method 1311, Revision 0, July 1992, and Method 7470A and 7420 or 7421, Revision 1, September 1994, of the EPA's manual on solid waste testing, and according to the TCLP procedures. The TCLP tests were conducted by independent laboratories using the test protocol developed by Science Applications International Corporation of Falls Church, Va. (the “SAIC Protocol”), herein incorporated by reference, which deals with the particulars of lamp preparation for the TCLP test. The data was analyzed using the statistical approach given in Chapter 9 of SW-846, Revision 0, September 1986.

Preliminary tests were first performed by an independent laboratory on SLS 15 Watt lamps having acceptable performance with respect to mercury but which did not have the lead-free components according to the invention. Testing was performed with complete lamps, lamps with the soldered button base removed, and with the button removed and using a printed circuit board, and circuit parts which were not soldered. In this testing, the 15 Watt lamps were borderline at 3.6 and 4.99 ppm lead. The EPA limit for lead is 5 ppm. It was concluded from these tests that the lamp components themselves contain significant amounts of lead. Next tests were performed on SLS 15 Watt lamps in which a lead-free solder is used on the printed circuit board and on the printed circuit board and soldered lamp components. In the TCLP tests for lead, each lamp was crushed into pieces smaller than ⅜ of an inch and placed in a container; then a volume of a weakly acidic buffer with a pH of 4.95 was added which is equal to 20 times the weight of the lamp, in grams. The container with the crushed lamp and solution was then tumbled for 18 hours end over end, the solution was filtered, and the amount of lead in the leachate was determined. In this testing, the 15 W lamp was found to contain 2.70 ppm leachable lead and less than 0.2 ppm mercury. The lamps were TCLP-compliant as to both mercury and lead.

While preferred embodiments of the invention have been shown and described, various other embodiments and modifications thereof will become apparent to those of ordinary skill in the art, and will fall within the scope of the invention as defined by the appended claims. For example, the given mercury ranges on a volume basis are applicable to other lengths and diameters of lamps having a mercury protective layer and a phosphor layer. Accordingly, the specification is to be considered to be illustrative only and not limiting.

1. An integrated CFL lamp which comprises the combination of (1) means to reduce the amount of leachable mercury in the spent lamp; and (2) means to reduce the amount of leachable lead in the spent lamp, said lamp, when subjected to TCLP standard tests in which a leachate is analyzed for mercury and lead content, containing no more than 0.2 ppm mercury and no more than 5 ppm lead mercury in the test leachate.

2. An integrated CFL lamp as claimed in claim 1, wherein said means to reduce the leachable lead is a circuit board that comprises a lead-free solder or such circuit board that comprises a lead-free solder in combination with at least one of a base portion and/or a lamp screw base portion that comprises a lead-free solder.

3. An integrated CFL lamp as claimed in claim 2, wherein said means to reduce the leachable
mercury is a burner dosed with either elemental mercury or an amalgam, at an initial level relative to the volume of the discharge space of between about 0.02 and about 0.2 μg/cm³ or a burner dosed with mercury and containing additives to reduce the amount of leachable mercury in the spent lamp.

4. A lighting unit which comprises:
at least one low-pressure mercury discharge lamp having at least one light-transmitting discharge vessel which is provided with a luminescent layer on an inner surface and which encloses a discharge space provided with a gas fill energizeable to a discharge state and mercury in amounts effective to render the lamp TCLP compliant as to mercury;
a housing base on which said lamp is mounted, having a base portion connected to a cap portion;
a ballast circuit arrangement disposed within the housing located at least partially on a circuit board and effective to energize said gas fill to such discharge state; and
means to reduce the amount of leachable lead and the amount of leachable mercury in the spent lamp to an amount sufficient to render the lamp TCLP-compliant as to both mercury and lead.

5. A lighting unit as claimed in claim 4, wherein said base is formed in a way suitable for mechanical and electrical connection to a lamp socket.

6. A lighting unit as claimed in claim 5, wherein the means by which the amount of leachable lead in the lamp is reduced is the use of a lead-free solder at least in the construction of the printed circuit board.

7. A lighting unit as claimed in claim 5, wherein the means by which the amount of leachable lead in the lamp is reduced is the use of a lead-free solder in the construction of (a) the circuit board or (b) the circuit board and a base portion of the lamp.

8. A lighting unit as claimed in claim 5, comprising an initial mercury dose selected to be between an upper limit of about 0.2 mg/cm³ of the volume enclosed by the discharge vessel and a lower limit of about 0.02 mg/cm³.

9. A lighting unit as claimed in claim 6, comprising an initial mercury dose selected to be between an upper limit of about 0.2 mg/cm³ of the volume enclosed by the discharge vessel and a lower limit of about 0.02 mg/cm³.

10. A lighting unit as claimed in claim 7, comprising an initial mercury dose selected to be between an upper limit of about 0.2 mg/cm³ of the volume enclosed by the discharge vessel and a lower limit of about 0.02 mg/cm³.

11. An integrated compact fluorescent lamp which comprises:
a cover having a base,
a light-transmitting outer bulb connected to the base and enclosing multiple low-pressure mercury discharge vessels, said discharge vessels being connected to one another to form a discharge path,
a lighting circuit contained in the cover and containing a printed circuit board extending at right angles to the longitudinal axis of the lamp, said printed circuit board comprising a lead-free solder and containing conductive tracks and a plurality of circuit elements that form an operating circuit for the lamp,
wherein said lamp, when subjected to TCLP standard tests in which a leachate is analyzed for mercury and lead content in the spent lamp, contains no more than 0.2 ppm mercury and no more than 5 ppm lead in the leachate.

12. An integrated compact fluorescent lamp as claimed in claim 11, wherein the discharge vessel is provided with a luminescent layer on an inner surface thereof.

13. An integrated compact fluorescent lamp as claimed in claim 11, wherein the discharge vessel encloses a discharge space that is provided with a filling of mercury and argon in a gastight manner.

14. An integrated compact fluorescent lamp as claimed in claim 12, wherein the inner surface of the discharge vessel is also provided with a mercury-protective layer and a phosphor coating disposed over the mercury-protective layer.
